(19) United States
(12) Patent Application Publication
(10) Pub. No.: US 2009/0208635 A1
(43) Pub. Date: Aug. 20, 2009

(54) METHOD FOR PRODUCING AN INSULATION TUBE AND METHOD FOR PRODUCING AN ELECTRODE

(76) Inventors: Akram ABDU, Berlin (DE); Stephan ZEDLER, Berlin (DE); Mark SCHURR, Berlin (DE)

Correspondence Address: DALINA LAW GROUP, P.C., 7910 IVANHOE AVE. #325, LA JOLLA, CA, 92037, US

(21) Appl. No.: 12/372,051

(22) Filed: Feb. 17, 2009

(30) Foreign Application Priority Data
Feb. 20, 2008 (DE) 10 2008 010 188.5

(51) Int. Cl. B05D 3/00

(52) U.S. Cl. 427/2.1

(57) ABSTRACT

The present invention relates to a method for producing an insulation tube (1) for an electrode for medical applications, preferably for implantation as part of a functional electrostimulation device and a method for producing such an electrode. The insulation tube (1) has a first, essentially hollow cylindrical layer (11) and at least one second layer (12), which is arranged on the lateral surface (15) of the first layer (11) and covers it at least partially. The invention is characterized in that the lateral surface (15) of the first layer (11) is cleaned in a cleaning step by means of a first liquid cleaning agent at a temperature below 30° C., preferably below 20° C., before applying the at least one second layer (12).

This application takes priority from German Patent Application DE 10 2008 010 188.5, filed 20 Feb. 2008, the specification of which is hereby incorporated herein by reference.

### BACKGROUND OF THE INVENTION

1. Field of the Invention

The present invention relates to a method for producing an insulation tube for an electrode for medical applications, preferably for implantation as part of a functional electrostimulation device, whereby the insulation tube has a first essentially hollow cylindrical layer and at least one second layer which is arranged on the lateral surface of the first layer and covers it at least partially. The present invention also relates to a method for manufacturing an electrode as defined above.

2. Description of the Related Art

An electrode for medical applications is preferably used as part of a functional electrostimulation device (FES) for electrical treatment of nerve cells or muscle cells in the diagnostic or therapeutic fields. Implantation systems for electrostimulation comprise, for example, heart pacemakers with a pulse generator for artificial stimulation of heart action or defibrillators. These electrostimulation devices usually comprise a physiologically compatible housing with a respective electronic circuit and a power supply, e.g., a battery. The housing has at least one connection point, where the electrode or electrodes can be connected. The electrode or electrodes serve to transmit the electric energy from the housing to the tissue to be treated and vice versa.

The term “electrode” in medical technology here refers not only to an element with which electric energy is transmitted according to the physical definition but also includes a line with an electric conductor together with its sheathing insulation, which is often designed as insulation tubing as well as all other functional elements which are fixedly connected to the line. In particular the electrode also comprises the so-called electrode tip by means of which the electric energy is introduced into the tissue to be treated. An electrode tip is frequently also equipped with anchoring elements or retaining structures with which the constancy of the spatial position of the transition point of the electric energy into the tissue to be treated is ensured. The electrode tip, which forms a transition point of the electric energy into the tissue, may be designed as a reference electrode, a stimulation electrode or a measurement electrode.

U.S. Pat. No. 7,221,982 B2 discloses an implantable cardiac electrode having an insulation tube consisting of two hollow cylindrical layers. The first layer here defines the insulation body of the electrode. The second layer, which serves as the protective layer, is applied along the outer surface of the first layer of material, namely along part of this surface. The surface of the first layer is activated to increase the adhesion and to allow the protective layer to be applied. The aforementioned document discloses various methods for doing so. For example, a plasma surface modification may be employed by means of a plasma-assisted method or an improved chemical gas-phase deposition method (chemical vapor deposition treatment). The plasma treatment comprises cleaning of the surface by means of gases. The plasma treatment also includes a plasma deposition process with a gas to form an anchoring layer (tie layer) as well as functionalization of the surface and activation thereof to improve adhesion. The traditional method for producing an electrode with an insulation tube is complex and expensive.

### BRIEF SUMMARY OF THE INVENTION

The object of the invention thus involves providing a method with which another layer can be applied rapidly and inexpensively to a first layer of an insulation tube (liner tube) for abrasion prevention. The adhesion to the liner tube should be as constant as possible and stable in the long term. Furthermore, the method must be as gentle as possible to ensure a long and reliable functioning of the electrode in the body treated with it.

The object defined above is achieved by a method for manufacturing an insulation tube in which the lateral surface of the first layer is cleaned in a cleaning step by means of a first liquid cleaning agent at a temperature below 30° C., preferably below 20° C. before applying the at least one second layer. Such a method can be performed rapidly and is also inexpensive. Through the stated method, the properties of the tube are homogenized, the surface is cleaned and short-chain crosslinked residues on the surface of the tube are removed. This achieves the result that a second layer which is applied subsequently to prevent abrasion adheres better to the substrate (i.e., the lateral surface of the first layer). The adhesion of the second layer to the liner tube is constant and stable over a long period of time. The inventive method, which includes a cleaning step, also referred to below as cold hardening (also cold leveling), is also gentle and thus ensures that an electrode with an insulation tube produced by the method according to this invention will function reliably and for a long time in the body of the treated patient.

In a preferred exemplary embodiment, the first cleaning agent is liquid CO₂. This cleaning agent is especially inexpensive and is available at any time.

It is especially advantageous if a adhesion mediator which preferably contains at least one compound from the group of silanes, siloxanes and carbinol, is applied to at least part of the lateral surface of the first layer before applying the at least one second layer. Such an adhesive mediator (primer) serves to further improve the adhesion of the abrasion-resistant second layer to the substrate.

In other cases, the use of a primer may be omitted through the inventive method with the cold curing cleaning step. This is advantageous because primers are often not entirely unobjectionable biologically. If the first layer consists of silicone, a primer could have a negative effect on its properties (e.g., elasticity and tensile strength). Furthermore, the properties of the applied primer are difficult to control when it is dried. Consequently, if defects occur during application, they are easily overlooked. Adhesion of the second layer applied to the primer would be impaired due to defects in application of the primer. Since the cold curing cleaning step on the primer may optionally be omitted due to the inventive method, the safety of the patient is increased and additional costs can be saved.

It is also preferable that after the cleaning step and before application of the at least one second layer, a plasma pretreatment of the lateral surface of the first layer is performed. The plasma pretreatment may be performed with or without the use of a process gas and instead of or in addition to the use of a primer. If the plasma pretreatment takes place in addition to the application of a primer, then the plasma pretreatment is performed before application of the primer. The plasma pretreatment, like the primer, serves to improve the adhesion of the second layer to the first layer. For example, a low-pressure plasma or different types of atmospheric plasmas may be used. In the case of atmospheric plasma, the use of a potential-free, open atmospheric plasma is preferred. The use of a corona discharge is also beneficial to create the plasma. For example, air and/or its constituents, water gas, silane and siloxane compounds are conceivable as process gases.

The lateral surface of the first layer cleaned by the inventive method is preferably provided with the at least one second layer in this way such that the at least one second layer is applied to the cleaned first layer by immersion, spraying or co-extrusion. These methods are inexpensive and are suitable for the materials of the at least one second layer in question.

In a preferred exemplary embodiment, the first layer contains silicone. The advantage of a layer with silicone is that silicone is a very adaptable material which is variable in some parameters such as the hardness. This makes it possible to adapt the physical properties of the finished electrode to the requirements in the body in a targeted manner. Another advantage of silicone is that it has a very good long-term stability and biocompatibility and thus can ensure reliable electric insulation of the electrode for decades.

It is also advantageous if the at least one second layer contains at least one polymer from the group consisting of polyurethane and silicone-polyurethane copolymer. Such a layer is especially abrasion-resistant and is thus excellently suited as abrasion protection.

The above object is also achieved by a method for producing an electrode in which the insulation tubing is produced by a method as defined above and then the insulation tubing is applied to a conductor element in such a way that it surrounds the latter on the outside and provides electric insulation. The insulation tubing is adhesively bonded to the conductor element or to elements applied thereto at the ends, at the transition points, in partial areas or over the entire length or is joined in a form-fitting and/or nonpositive manner in some other way. Such an electrode has the advantage that it can be manufactured easily and inexpensively and the functional reliability of the electrode is improved.

As described above, the coating with the second layer results in an improvement in the friction properties and handling during implantation and to an increase in the abrasion resistance and thus also the long-term stability and use time of the electrode in the patient. This is due mainly to the fact that due to the cold curing in combination with the second layer and optionally the primer, an insulation tubing whose properties can be kept within a very narrow frame is produced. Due to the cleaning, short-chain uncrosslinked residues and dirt from the tube manufacturing process are largely washed out of the tube. Therefore, the primer and/or the second layer adhere better to the substrate. In parallel with that, the cleaning process levels out the properties (bending strength, tensile strength, hardness, torsional rigidity, surface properties, . . . ) of the basic tubing. Tempering at high temperatures for a longer period of time (150-220° C. for 2-5 hours) thus becomes superfluous. The basic material is thus exposed to a smaller load. The basic tubing leveled in this way has an optimized surface to which the second layer can be applied. In this way, the second layer can be made thinner than with a traditional tubing which is not pretreated by cold curing. The electrode may thus turn out to be thinner (increased flexibility, more space for implantation of other electrodes in the venous system). Due to the uniform properties, there is also a further improvement in the long-term stability and improved handling during implantation (the electrode always feels the same; only in this way is it possible to ensure that the physician will become “accustomed” to such a feeder line and can thus implant it more rapidly and more efficiently). From a structural standpoint, more freedom in design of the electrodes can thus be acquired so that the electrode can be adapted to requirements in the body to a greater extent than before. This achieves an increased patient safety.

### BRIEF DESCRIPTION OF THE DRAWINGS

Additional goals, features and possible applications of the invention are derived from the following description of the inventive methods on the basis of the FIGURE. All the features described and/or illustrated here either alone or any combination may constitute the subject matter of the present invention, even independently of how they are combined in the individual claims or their reference back to previous claims.

FIG. 1 shows a cross section through insulation tubing for an electrode for medical applications produced by the inventive method.

### DETAILED DESCRIPTION OF THE INVENTION

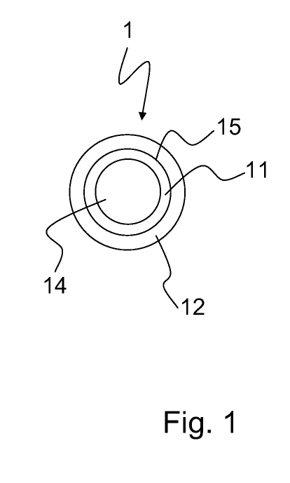

The insulation tube 1 shown in FIG. 1 has a first layer (liner tube) 11 that is designed to be essentially a hollow cylinder. A second layer 12 is arranged on the first layer 11, running concentrically with the first layer. The first electrically insulating layer 11 is preferably made of silicone, while the second layer 12 is preferably made of polyurethane or a silicone-polyurethane copolymer and serves as abrasion protection. After production of the insulation tubing, the conductor element or the conductor elements (not shown) of the electrode are arranged in the central through-opening 14 in the first layer 11 and are electrically insulated and protected by the insulation tubing 1. The conductor element or the conductor elements serve to transmit electric energy from the housing of the functional electrostimulation device (e.g., heart pacemaker) to the site to be treated.

To produce such an insulation tube 1, first the lateral surface 15 of a tube consisting only of the first layer 11 is cleaned in liquid CO₂ (cold curing), wherein another cleaning agent may be added to the CO₂ if necessary. Next, the second layer 12 is applied to the lateral surface 15 of the first layer 11 by dipping, spraying or co-extrusion. To do so, a solution of the material of the second layer may be used or the basic substance may be sprayed onto the tube so that it polymerizes directly on the lateral surface 15 of the liner tube 11. If necessary, before applying the second layer 12 and after the cold curing cleaning step, a primer may be applied to the lateral surface and/or a plasma pretreatment of the lateral surface 15 may be performed with or without the use of a process gas.

Through the inventive method with the cold curing cleaning step, the liner tube 11 is cleaned and put in a state in which its properties are almost constant, so that the coating 12 adheres better and in a more defined manner. The mechanical and biological stability of the electrode as a whole therefore increases with the insulation tube 1 in the body. In this way, silicone feeder lines can be manufactured inexpensively in a large number of parts. Furthermore, this makes it possible to implement layers for abrasion prevention that are thinner than is the case with traditional electrodes.

### LIST OF REFERENCE NUMERALS

1 insulation tube
11 first layer of the insulation tube 1
12 second layer of the insulation tube 1
14 central through-opening in the first layer 11
15 lateral surface of the first layer 11

What is claimed is:

1. A method for producing an insulation tube (1) for an electrode for medical applications,
including for implantation as part of a functional electrostimulation device, comprising:
obtaining an insulation tube (1) having a first layer (11) comprising an essentially hollow cylindrical layer;
cleaning a lateral surface (15) of the first layer (11) using a first liquid cleaning agent at a temperature below 30° C.; and,
applying at least one second layer (12) on the lateral surface (15) of the first layer (11) wherein said at least one second layer (12) covers the first layer (11) at least partially.

2. The method according to claim 1, wherein the cleaning comprises using the first liquid cleaning agent at a temperature below 20° C.

3. The method according to claim 1, wherein the cleaning comprises using liquid CO₂ as the first liquid cleaning agent.

4. The method according to claim 1, further comprising:
applying a primer to at least a part of the lateral surface (15) of the first layer (11) after the cleaning and before the applying the at least one second layer (12), wherein said primer contains at least one compound from a first group that comprises silanes, siloxanes and carbinol.

5. The method according to claim 1, further comprising:
performing a plasma pretreatment of the lateral surface (15) of the first layer (11) after the cleaning and before the applying the at least one second layer (12).

6. The method according to claim 1, wherein said applying the at least one second layer (12) includes immersing, spraying or using co-extrusion.

7. The method according to claim 1, wherein said obtaining the insulation tube (1) having the first layer (11) comprises obtaining the insulation tube (1) having the first layer (11) wherein the first layer (11) contains silicone.

8. The method according to claim 1, wherein said applying the at least one second layer (12) includes applying at least one polymer from a second group that comprises polyurethane and a silicone-polyurethane copolymer.

9. A method for producing an electrode for medical applications, including for implantation as part of a functional electrostimulation device, comprising:
producing the insulation tube (1) according to claim 1; and,
applying the insulation tube (1) to a conductor element so that the insulation tube (1) surrounds the conductor element and insulates the conductor element electrically.
